(19) United States
(12) Patent Application Publication
(10) Pub. No.: US 2012/0013886 A1
(43) Pub. Date: Jan. 19, 2012

(54) Distance Measuring Module And Electronic Device Including The Same

(75) Inventors: Jong Woo Park, Seoul (KR); Hong Ki Kim, Yongin (KR)

(73) Assignee: SAMSUNG ELECTRO-MECHANICS CO., LTD., Suwon (KR)

(21) Appl. No.: 13/064,735

(22) Filed: Apr. 12, 2011

(30) Foreign Application Priority Data
Jul. 15, 2010 (KR) 10-2010-0068414

(51) Int. Cl. G01C 3/08

(52) U.S. Cl. 356/4.01

(57) ABSTRACT

Provided is a distance measuring module including an imaging lens imaging an object, a light source part emitting reference light to the object through the imaging lens, and a light receiving part receiving reflected light reflected by the object and made incident thereupon through the imaging lens, wherein a distance from the object is measured on the basis of a time of flight of the reflected light having reached the light receiving part.

### CROSS-REFERENCE TO RELATED APPLICATIONS

This application claims the priority of Korean Patent Application No. 10-2010-0068414 filed on Jul. 15, 2010, in the Korean Intellectual Property Office, the disclosure of which is incorporated herein by reference.

### BACKGROUND OF THE INVENTION

1. Field of the Invention

The present invention relates to a distance measuring module and an electronic device including the same, and more particularly, to a distance measuring module capable of measuring a distance by emitting light to a target for distance measurement and causing the light reflected from the target to pass through an imaging lens, and an electronic device including the same.

2. Description of the Related Art

In general, a distance measuring system measures a distance to an object by using light such as a laser beam. This distance measuring system adopts a method of measuring the Time of Flight (TOF) of light or a Position Sensitive Device (PSD) method using the fact that an angle of light reflected from a remote object is different from that of light reflected from a nearby object.

The distance measuring system using TOF measures distance by measuring TOF between a time point at which a light source emits reference light for distance measurement and a time point at which an optical sensor detects the reference light reflected by a target object for distance measurement.

Typically, an optical system that measures distance by using a laser includes a light source for emitting light to an object, and a light receiver collecting light scattered by the object. The light source and the light receiver are spaced apart from each other at a predetermined distance by using separate components therefor.

However, such an optical system, when applied to a module, increases the module size, and light reception efficiency is degraded due to eccentric optical axes between a light emitter and a light receiver.

Moreover, in the case in which the above distance measuring module is applied to an electronic device, the internal space thereof cannot be efficiently utilized.

### SUMMARY OF THE INVENTION

An aspect of the present invention provides a distance measuring module capable of measuring a distance by emitting light to an object for distance measurement and causing the light reflected from the object to pass through an imaging lens, and an electronic device including the same.

According to an aspect of the present invention, there is provided a distance measuring module including: an imaging lens imaging an object; a light source part emitting reference light to the object through the imaging lens; and a light receiving part receiving reflected light reflected by the object and made incident thereupon through the imaging lens. A distance to the object is measured on the basis of a time of flight of the reflected light having reached the light receiving part.

The distance measuring module may further include: an image sensor disposed in a first optical axis path at the rear of the imaging lens to which the image of the object is transmitted; and a first reflector part disposed between the imaging lens and the image sensor and directing the reference light, traveling along a second optical axis path, toward the imaging lens.

The first reflector part may be a reflective mirror, a prism or a beam splitter.

The first optical axis path and the second optical axis path may be perpendicular to each other and have optical axes with centers thereof coinciding with each other.

The distance measuring module may further include a second reflector part directing the reflected light, traveling along the second optical axis path from the first reflector part, toward the light receiving part.

The second reflector part may have a hole allowing the reference light to pass therethrough.

The distance measuring module may further include a condenser lens disposed between the light source part and the second reflector part, and gathering the reference light so as to allow the reference light to pass through the hole.

The distance measuring module may further include a light pointing part disposed to allow light from the light pointing part to pass through the imaging lens, the light pointing part pointing at the object.

The light pointing part may be a laser light source within a visible band.

The light source part may be a pulse generator providing light in pulse waveforms.

The light source part may be an infrared light source.

According to another aspect of the present invention, there is provided an electronic device including: an imaging lens disposed on an outer surface of a case and imaging an object; a light source part disposed in an internal space of the case and emitting reference light to the object via the imaging lens; a light receiving part receiving reflected light reflected by the object and made incident into the internal space via the imaging lens; and a display displaying a distance calculated on the basis of a time of flight of the reference light and the reflected light.

The electronic device may further include: an image sensor disposed in a first optical axis path at the rear of the imaging lens to which the image of the object is transmitted; and a first reflector part disposed between the imaging lens and the image sensor and directing the reference light, traveling along a second optical axis path, toward the imaging lens.

The first reflector part may be a reflective mirror, a prism or a beam splitter.

The first optical axis path and the second optical axis path may be perpendicular to each other and have optical axes with centers thereof coinciding with each other.

The electronic device may further include a second reflector part directing the reflected light, traveling along the second optical axis path from the first reflector part, toward the light receiving part.

The second reflector part may have a hole allowing the reference light to pass therethrough.

The electronic device may further include a condenser lens disposed between the light source part and the second reflector part, and gathering the reference light so as to allow the reference light to pass through the hole.

The electronic device may further include a light pointing part disposed to allow light from the light pointing part to pass through the imaging lens, the light pointing part pointing at the object.

The light pointing part may be a laser light source within a visible band.

The light source part may be a pulse generator providing light in pulse waveforms.

The light source part may be an infrared light source.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view illustrating an electronic device including a distance measuring module according to an exemplary embodiment of the present invention;

FIG. 2 is a schematic view illustrating how reference light is emitted from a distance measuring module according to an exemplary embodiment of the present invention;

FIG. 3 is a schematic view illustrating how reflected light is made incident upon a distance measuring module according to an exemplary embodiment of the present invention;

FIG. 4 is a schematic view illustrating a path of image information regarding an object, and a path of reflected light toward a light receiving part in a distance measuring module according to an exemplary embodiment of the present invention; and

FIG. 5 is a schematic view illustrating a distance measuring module further including a light pointing part according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. While those skilled in the art could readily devise many other varied embodiments that incorporate the teachings of the present invention through the addition, modification or deletion of elements, such embodiments may fall within the scope of the present invention.

The same or equivalent elements are referred to by the same reference numerals throughout the specification.

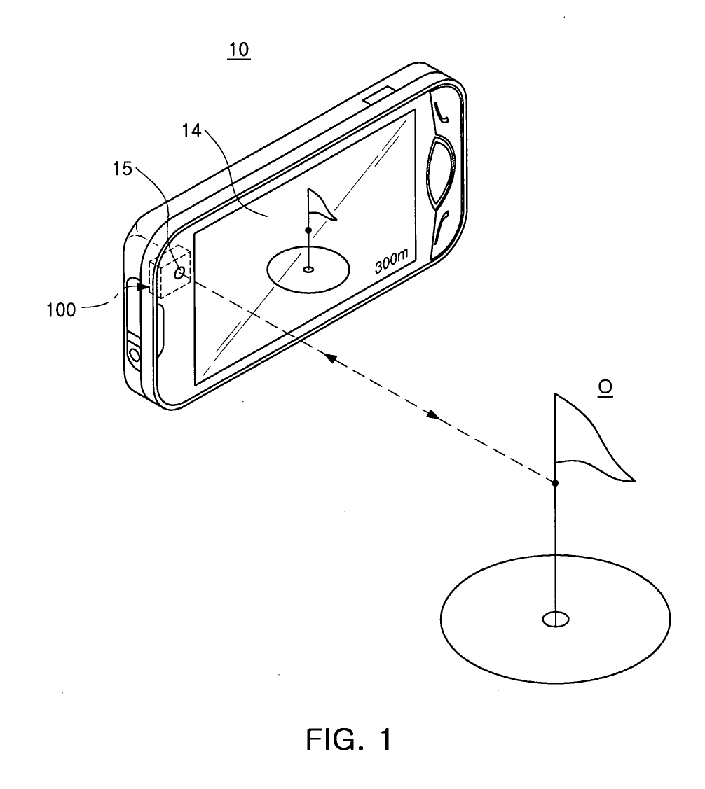

FIG. 1 is a schematic perspective view illustrating an electronic device including a distance measuring module according to an exemplary embodiment of the present invention.

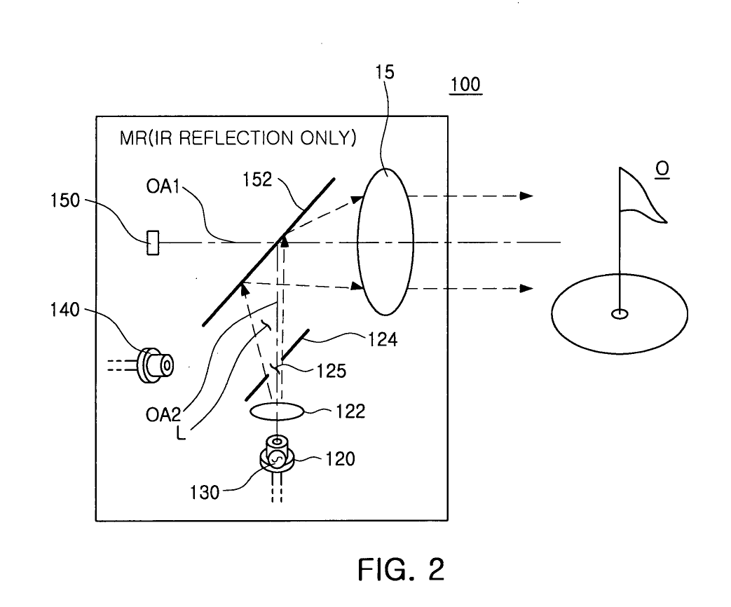

Referring to FIG. 1, an electronic device including a distance measuring module 100, according to an exemplary embodiment of the invention, may include an imaging lens 15, a light source part 120 (see FIG. 2), a light receiving part 140 (see FIG. 2) and a display 14.

A mobile communications terminal 10 is exemplified as the electronic device in this exemplary embodiment of the invention. However, the present invention is not limited thereto, and may be applied to a distance measuring device that displays distance only.

The imaging lens 15 is an optical lens capable of imaging an object. This imaging lens 15 may be disposed on the outer surface of a case 12 of the mobile communications terminal 10.

The display 14 of the mobile communications terminal 10 may display image information of an object, imaged by the imaging lens 15.

Furthermore, the display 14 may display distance information calculated by the distance measuring module 100 including the light source part 120 and the light receiving part 140.

Hereinafter, the distance measuring module 100, according to an exemplary embodiment of the invention, will be described in detail with reference to FIGS. 2 through 4. The technical features of the distance measuring module 100, which will be described in the following sections, may all be applicable to the electronic device according to an exemplary embodiment of the invention.

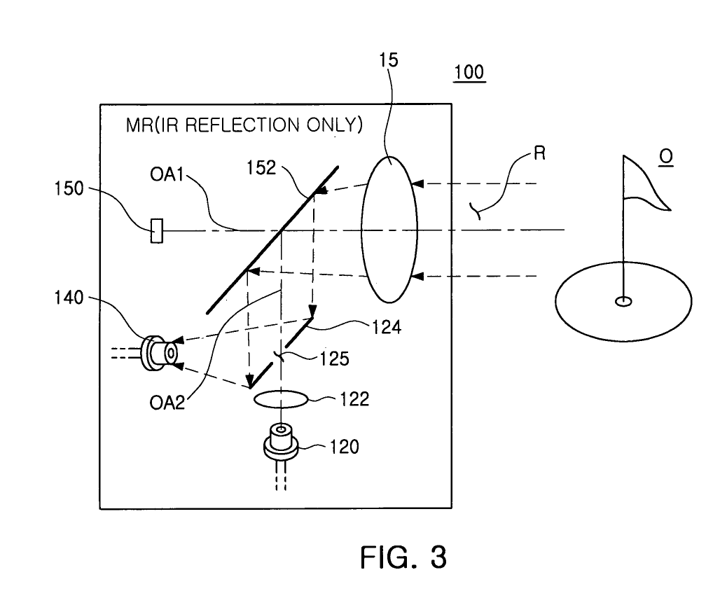

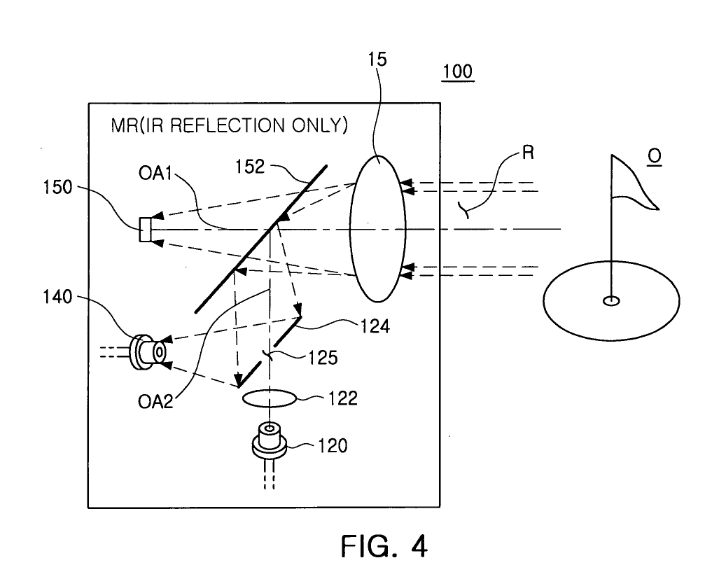

FIG. 2 is a schematic view illustrating how reference light is emitted from the distance measuring module according to an exemplary embodiment of the present invention. FIG. 3 is a schematic view illustrating how reflected light is made incident upon the distance measuring module according to an exemplary embodiment of the present invention. FIG. 4 is a schematic view illustrating a path of image information regarding an object, and a path of reflected light toward the light receiving part in the distance measuring module according to an exemplary embodiment of the present invention.

Referring to FIGS. 2 through 4, the distance measuring module 100, according to an exemplary embodiment of the invention, may include the imaging lens 15, the light source part 120 and the light receiving part 140.

The imaging lens 15 is an optical lens imaging an object ‘O’. The imaging lens 15 allows reference light ‘L’, emitted from the light source part 120, and reflected light ‘R’ from the object ‘O’ to pass therethrough. That is, the emission of reference light ‘L’ and the incidence of reflected light ‘R’ are made through a single imaging lens 15, which significantly contributes to a reduction in the overall size of the mobile communications terminal including the distance measuring module 100.

The light source part 120 may emit reference light ‘L’ to the object ‘O’ via the imaging lens 15. The light receiving part 140 may receive reflected light ‘R’, reflected by the object ‘O’ and then made incident thereupon via the imaging lens 15.

The distance measuring module 100 may calculate the distance from the object ‘O’ on the basis of time of flight of the reflected light ‘R’ having reached the light receiving part 140, and provide the display 14 with information regarding the calculated distance.

The light source part 120 may not affect human vision by using an infrared light source of 900 nm or higher. Furthermore, the light source part 120 may be configured as a pulse generator 130 that provides light in pulse waveforms. Since light is provided in pulse waveforms by the use of the pulse generator 130, the time of flight of light reflected in pulse waveforms can be consecutively calculated so that distance can be measured more accurately.

Furthermore, the distance measuring module 100 may further include an image sensor 150 disposed in a first optical axis path OA1 at the rear of the imaging lens 15 to which an image of the object ‘O’ is transmitted.

The image sensor 150 sends an image to the display 14, so that a user can easily measure the distance from the object ‘O’ through watching the image.

The distance measuring module 100 may further include a reflector part in order to efficiently utilize the internal space of the electronic device 10 and to cause the optical axes of reference light ‘L’ and reflected light ‘R’ to be concentric with each other (i.e., to have the centers thereof coinciding with each other).

A first reflector part 152 is disposed between the imaging lens 15 and the image sensor 150, and serves to direct the reference light ‘L’, traveling along a second optical axis path OA2, toward the imaging lens 15.

The first reflector part 152 may be configured as a reflective mirror, a prism or a beam splitter. Here, the first reflector part 152 reflects only infrared light.

At this time, the first optical axis path OA1 and the second optical axis path OA2 may be perpendicular to each other with their centers coinciding with each other, and for efficient spatial utilization.

As shown in FIG. 3, a second reflector part 124 may serve to direct the reflected light ‘R’, traveling along the second optical axis path OA2 from the first reflector part 152, toward the light receiving part 140.

In this case, the second reflector part 124 may be a reflective mirror having a hole 125 allowing the reference mirror ‘L’ to pass therethrough.

A condenser lens 122 may be disposed between the second reflector part 124 and the light source part 120. The condenser lens 122 may prevent the scattering of light in order to cause the reference light ‘L’, emitted from the light source part 120, to pass through the hole 125 of the second reflector part 124.

Referring to FIG. 4, image information of the reflected light ‘R’, reflected by the object ‘O’, forms an image on the image sensor 150. Furthermore, the reflected light ‘R’ is directed to the second optical axis path OA2 by the first reflector part 152, and subsequently directed by the second reflector part 124 so as to be detected by the light receiving part 140.

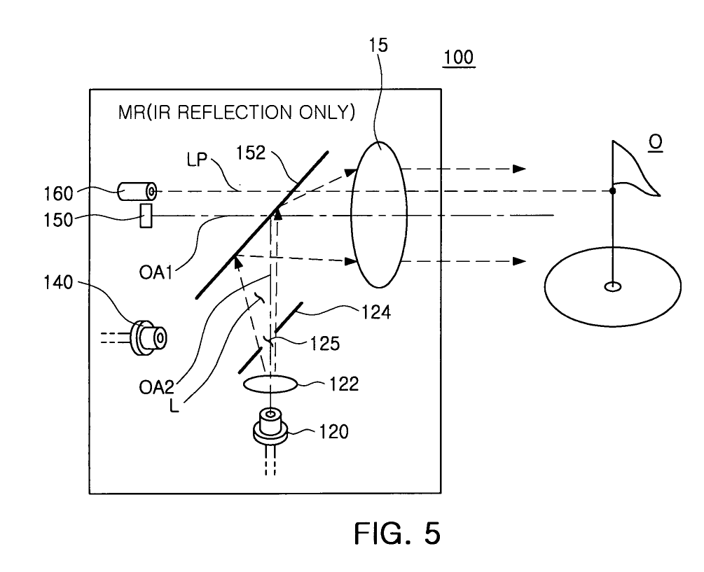

FIG. 5 is a schematic view illustrating the distance measuring module further including a light pointing part, according to an exemplary embodiment of the present invention.

Referring to FIG. 5, the distance measuring module 100 may further include a light pointing part 160 disposed such that light from the light pointing part 160 passes through the imaging lens 15. The light pointing part 160 serves to point at the object ‘O’.

The light pointing part 160 is a laser light source that emits visible laser beams, and may indicate a measuring position in the case in which an image of an object is not clear due to dark surroundings.

As set forth above, according to the distance measuring module and the electronic device including the same according to exemplary embodiments of the invention, the emission of reference light and the incidence of reflected light are made through a single imaging lens, thereby contributing to a reduction in the size of a mobile communications terminal including the distance measuring module and also a reduction in the number of components provided therein.

Furthermore, reference light and reflected light have optical axes with their centers coinciding each other, thereby enhancing light-reception efficiency and improving accuracy in distance measurement.

Also, the use of a reflector part increases the efficiency of spatial utilization.

Furthermore, the use of a light pointing part allows for the indication of a measuring position when an image of an object is obscure due to dark surroundings.

While the present invention has been shown and described in connection with the exemplary embodiments, it will be apparent to those skilled in the art that modifications and variations can be made without departing from the spirit and scope of the invention as defined by the appended claims.

What is claimed is:

1. A distance measuring module comprising:
an imaging lens imaging an object;
a light source part emitting reference light to the object through the imaging lens; and
a light receiving part receiving reflected light reflected by the object and made incident thereupon through the imaging lens,
wherein a distance to the object is measured on the basis of a time of flight of the reflected light having reached the light receiving part.

2. The distance measuring module of claim 1, further comprising:
an image sensor disposed in a first optical axis path at the rear of the imaging lens to which the image of the object is transmitted; and
a first reflector part disposed between the imaging lens and the image sensor and directing the reference light, traveling along a second optical axis path, toward the imaging lens.

3. The distance measuring module of claim 2, wherein the first reflector part is a reflective mirror, a prism or a beam splitter.

4. The distance measuring module of claim 2, wherein the first optical axis path and the second optical axis path are perpendicular to each other, and have optical axes with centers thereof coinciding with each other.

5. The distance measuring module of claim 2, further comprising a second reflector part directing the reflected light, traveling along the second optical axis path from the first reflector part, toward the light receiving part.

6. The distance measuring module of claim 5, wherein the second reflector part has a hole allowing the reference light to pass therethrough.

7. The distance measuring module of claim 6, further comprising a condenser lens disposed between the light source part and the second reflector part, and gathering the reference light so as to allow the reference light to pass through the hole.

8. The distance measuring module of claim 1, further comprising a light pointing part disposed to allow light from the light pointing part to pass through the imaging lens, the light pointing part pointing at the object.

9. The distance measuring module of claim 8, wherein the light pointing part is a laser light source within a visible band.

10. The distance measuring module of claim 1, wherein the light source part is a pulse generator providing light in pulse waveforms.

11. The distance measuring module of claim 1, wherein the light source part is an infrared light source.

12. An electronic device comprising:
an imaging lens disposed on an outer surface of a case and imaging an object;
a light source part disposed in an internal space of the case and emitting reference light to the object via the imaging lens;
a light receiving part receiving reflected light reflected by the object and made incident into the internal space via the imaging lens; and
a display displaying a distance calculated on the basis of a time of flight of the reference light and the reflected light.

13. The electronic device of claim 12, further comprising:
an image sensor disposed in a first optical axis path at the rear of the imaging lens to which the image of the object is transmitted; and
a first reflector part disposed between the imaging lens and the image sensor and directing the reference light, traveling along a second optical axis path, toward the imaging lens.

14. The electronic device of claim 13, wherein the first reflector part is a reflective mirror, a prism or a beam splitter.

15. The electronic device of claim 13, wherein the first optical axis path and the second optical axis path are perpendicular to each other, and have optical axes with centers thereof coinciding with each other.

16. The electronic device of claim 13, further comprising a second reflector part directing the reflected light, traveling along the second optical axis path from the first reflector part, toward the light receiving part.

17. The electronic device of claim 16, wherein the second reflector part has a hole allowing the reference light to pass therethrough.

18. The electronic device of claim 17, further comprising a condenser lens disposed between the light source part and the second reflector part, and gathering the reference light so as to allow the reference light to pass through the hole.

19. The electronic device of claim 12, further comprising a light pointing part disposed to allow light from the light pointing part to pass through the imaging lens, the light pointing part pointing at the object.

20. The electronic device of claim 19, wherein the light pointing part is a laser light source within a visible band.

21. The electronic device of claim 12, wherein the light source part is a pulse generator providing light in pulse waveforms.

22. The electronic device of claim 12, wherein the light source part is an infrared light source.
